(19) United States
(12) Patent Application Publication
(10) Pub. No.: US 2015/0035204 A1
(43) Pub. Date: Feb. 5, 2015

(54) SILICONE ADHESIVE TAPES AND METHOD OF MASKING USING SAME

(71) Applicant: Intertape Polymer Corp., Sarasota, FL (US)

(72) Inventors: Cynthia Stoner, Olive Branch, MS (US); Paul E. Rhude, Fort Gratiot, MI (US)

(21) Appl. No.: 14/449,797

(22) Filed: Aug. 1, 2014

Related U.S. Application Data
(60) Provisional application No. 61/861,240, filed on Aug. 1, 2013.

(51) Int. Cl. C09J 7/04; B29C 33/68; B29C 33/58

(52) U.S. Cl. CPC C09J 7/048; B29C 33/58; B29C 33/68; C09J 7/045; B29K 2883/005; B29K 2809/06; C09J 2483/003; C09J 2400/283; C09J 2409/006; C09J 2201/122; C09J 2201/606; C09J 2483/00
USPC 264/334; 428/353; 428/352; 156/249

(57) ABSTRACT

Disclosed is a masking article such as a masking tape, roll of masking tape, masking sheet, etc. that has a substrate or backing with a primer layer on a first major surface thereof and a pressure-sensitive silicone adhesive layer on the primer layer such that the primer layer is positioned between the backing and the adhesive layer. The masking article is able to adhere to a semi-permanent release composition at greater than about 10 oz/in as measured with a 90° peel test to stainless steel with a 4.5 lb roll down. A method of masking a mold having a semi-permanent release applied thereto with the disclosed masking article is disclosed. The method includes the steps of providing a mold having the semi-permanent release agent applied thereto and applying a masking article to an area of the mold with the masking article at least partially adhered to the semi-permanent release agent.

### RELATED APPLICATIONS

This application claims the benefit of U.S. provisional Application No. 61/861,240, filed Aug. 1, 2013.

### TECHNICAL FIELD

The present invention relates to silicone adhesive tapes, in particular, silicone pressure sensitive adhesive tapes for masking a surface having a semi-permanent release applied thereto to protect that surface.

### BACKGROUND

Silicone adhesive tapes, such as Scapa 2595 specialty masking tape, are available for masking metals such as polished and anodized aluminum, chemically etched steel, passivated cadmium, magnesium, various types of copper containing alloys and brass. However, this brand of silicone masking tape provides unsatisfactory masking ability when applied to a semi-permanent release agent or composition. Traditional masking tape, like Orange Masking Tape by Anchor which is a natural rubber based adhesive platform, does not stick well to semi-permanent mold releases.

There are two basic types of mold releases and release agents: non-permanent and semi-permanent. Non-permanent products may require re-application after each use, usually in the form of a mold release spray. Semi-permanent mold releases and release agents are sensitive to moisture and other chemicals, but typically last longer in the mold. Semi-permanent releases provide chemical- and heat-resistant barriers between the mold and the part. Unlike wax/parting film system, semi-permanent mold releases bond to the mold surface rather than the part. These release agents are intended to remain in useful form on the mold surface for an extended period, enabling production of multiple parts with a single application thereof.

Certain molding manufacturers are moving toward the use of semi-permanent releases in their molds, for example, marine manufacturers are using semi-permanent release agents in boat hull molds, in particular, in fiberglass molds. Molding techniques often include the use of a mask such as a masking tape. It is desirable that the masking tape adhere thereto and have clean removal therefrom.

### SUMMARY

In one aspect, improved silicone masking tapes are disclosed that adhere to semi-permanent releases and have clean removal when removed therefrom, and, more particularly, an improved silicone masking tape having a silicone primer layer applied to a backing between the backing and a silicone pressure-sensitive adhesive layer that enhances the masking ability of the tape by improving the tapes' adhesion to and clean removal from a semi-permanent release agent.

In one embodiment, the silicone masking tape includes a paper backing including a saturant and having opposite first and second major surface, the first major surface having a primer layer comprising silicone or silane moieties thereon and a silicone pressure-sensitive adhesive layer on the primer layer with the primer layer positioned between the backing and the adhesive layer. The masking tape has the characteristic of adhering to a semi-permanent release composition at greater than about 10 oz/in or even greater than 14 oz/in as measured with a 90° peel test to stainless steel with a 4.5 lb roll down. In one embodiment, the saturant includes styrene-butadiene rubber.

In another aspect, a method is disclosed. The method is a method of masking a mold having a semi-permanent release applied thereto with a silicone pressure-sensitive masking article having a construction similar to that described above. The method includes the steps of providing a mold having the semi-permanent release agent applied thereto and applying a masking article to an area of the mold with the masking article at least partially adhered to the semi-permanent release agent.

The method may also include the steps of molding an article in the mold, removing the article from the mold; and removing the masking article from the mold. The masking article provides clean removal from the semi-permanent release agent.

In one embodiment, the primer layer includes silicone as about 5% to about 15% weight solids. In another embodiment, the primer layer includes silicone as about 8% to about 10% weight solids. The primer layer may have a coat weight of about 10 gsm to about 30 gsm or about 20 gsm to about 22 gsm.

### BRIEF DESCRIPTION OF THE DRAWINGS

FIG. 1 is a perspective view of a roll of masking tape.

FIG. 2 is a cross-sectional view of the masking tape of FIG. 1 taken along line 2-2, illustrating one embodiment of the layered construction of the masking tape.

FIG. 3 is a cross-sectional view illustrating another embodiment of the layered construction of a masking tape.

FIG. 4 is a cross-sectional view of a boat hull mold having a semi-permanent release applied thereto and masked with one embodiment of the disclosed masking tapes.

FIG. 5 is a graphical illustration of the steps of one embodiment of a method of masking a mold using one embodiment of the disclosed masking tapes.

### DETAILED DESCRIPTION

The following detailed description will illustrate the general principles of the invention, examples of which are additionally illustrated in the accompanying drawings. In the drawings, like reference numbers indicate identical or functionally similar elements.

One example of an adhesive tape is a pressure sensitive tape such as a masking tape, preferably herein masking silicone tapes. The tapes disclosed herein include a silicone pressure sensitive adhesive layer disposed on a major surface of a backing The adhesive layer is securely bound to the backing by a primer layer positioned therebetween. Such a construction of the tapes provides an effective masking tape that protects the masked surface from exposure to applied substances. The construction of the tapes reduces or prevents the travel of the applied substances through the primer-backing interface and/or the adhesive-primer interface. The mechanism by which the construction of the silicone tapes reduces or prevents the travel of the harmful or corrosive materials may be by physical or chemical means. The tape has adhesion to gel coats, is solvent resistant, is conformable to the surface of the adherend, and provides clear, clean mask lines.

In addition to adhesive tapes, it is to be understood that paper or synthetic drop cloths, masking sheets, or other masking articles may also benefit from the present invention. Paper and synthetic drop cloths or masking sheets are thin sheets of material that are used in masking large areas during such operations as painting, cleaning with solvents, applying a material to be molded such as fiberglass. These drop cloths and masking sheets are typically much wider than the adhesive tapes used in masking objects and may have adhesives over their entire bottom surface, over only a portion of their bottom surface, or not at all.

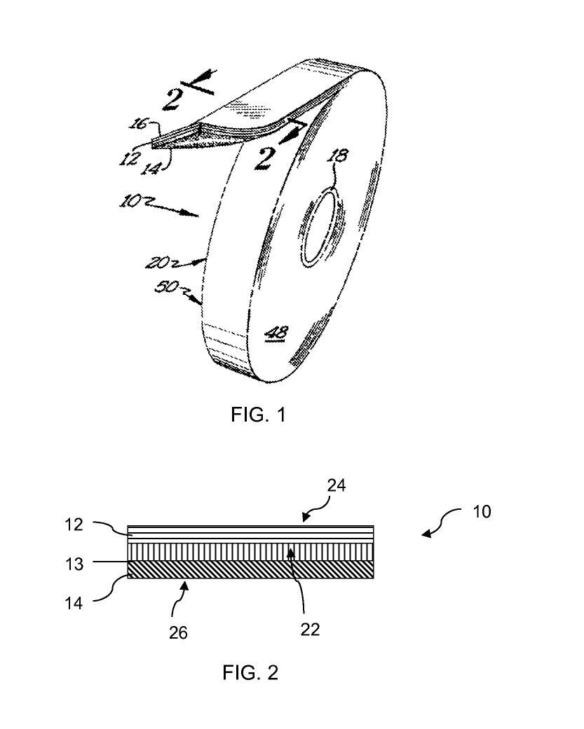

In some instances, as illustrated in FIG. 1, tape 10 may have an adhesive layer 14 disposed on a first major surface 22 of the backing 12 and a top layer 16 disposed on a second major surface 24 thereof. The top layer 16 may be impervious or at least resistant to liquids. In one embodiment, top layer 16 is a release coat. Tape 10 is most often wound on a core 18 to form a roll 20 of tape 10. Tape 10 is typically formed in large sheets (not shown) many times wider than the roll illustrated in FIG. 1. These sheets of tape 10 are rolled onto an elongate core to form an elongate roll of tape. The elongate roll is then cut into individual rolls 20 of predetermined widths having cut sides 48, 50, which may have adhesive from the adhesive layer 14 exposed thereon.

The adhesive layer 14 may be a pressure-sensitive silicone adhesive composition. Such an adhesive is beneficial because it provides the tape or article with a construction that is capable of adhering to a semi-permanent release composition. Release compositions, sometimes referred to as mold releases or release agents, are film-forming lubricating oils, solid lubricants, waxes, or fluids that prevent other materials from sticking or adhering to an underlying surface. Unlike permanent non-stick coatings, release agents typically require replenishment and are non-curing. Release compositions are useful to coat molds to protect the mold so that the resulting molded article is more easily removable from the mold. This also increases the mold's life in allowing it to be reused numerous times.

The tape's construction is such that it is capable of adhering to and being cleanly removed from Kraft paper and poly drapes.

Referring now to FIG. 2, tape 10 may include backing 12 having opposite first and second major surfaces 22, 24 with a primer layer 13 on the first major surface 22 and a pressure-sensitive silicone adhesive layer 14 disposed on the primer layer 13 with the primer layer 13 positioned between the backing 12 and the adhesive layer 14. The adhesive layer 14 defines an adhesive surface 26 of tape 10.

Primer layer 13 provides the tape or article with the characteristic of clean removal during demask. The primer layer 13 improves the adhesion of the pressure-sensitive silicone adhesive layer 14 to the backing 12 such that the adhesive layer 14 stays adhered to the backing during demask rather than being left behind on the masking surface as a residue.

Turning now to the various layers of the tape's construction, the backing 12 may be a single layer or a multi-layer construction that includes backing materials, release liners, release coated materials and combinations thereof. The tape's backing construction may include polymeric film, paper, metal foil, foam, reinforced, double-faced and transfer tape. Other possible tape constructions include composite backings, composite liners, and combinations thereof. The tape may include other layers and elements found in conventional adhesive tapes, such as coatings for rendering the tape impervious or resistant to fluids, reinforcements for adding strength to the tape, release agents, etc.

Examples of backing materials include cellophane, acetate, fiber, polyester, vinyl, polyethylene, polypropylene including, e.g., monoaxially oriented polypropylene and biaxially oriented polypropylene, polytetrafluoroethylene, polyvinylfluoroethylene, polyurethane, polyimide, paper (e.g., Kraft paper), woven webs (e.g., cotton, polyester, nylon and glass), nonwoven webs, foil (e.g., aluminum, lead, copper, stainless steel and brass foils) and combinations thereof. In one embodiment, the backing 12 includes a paper backing material such as a crepe paper. One crepe paper suitable for tapes is Kraft paper. A backing 12 that includes a paper backing material is advantageous with the silicone adhesive layer 14 in that it provides a masking tape that is hand tearable and that corners well (i.e., it has the ability to turn a radius without tearing during application to an adherend).

The paper backing 12 includes a saturant at about 20% to about 60% saturant pick-up. In one embodiment, the paper backing has a saturant present at about 25% to about 50% saturant pick-up. In another embodiment, the paper backing has a saturant present at about 27% to about 40% saturant pick-up. The saturant may provide the paper backing of the masking tape with desirable properties such as water resistance, wet strength, flexibility, softness, durability, and fold resistance. Importantly, the paper backing with the saturant provides clean demasking and superior cornering during application of the tape to the desired surface to be masked. Suitable saturants include for example, synthetic or natural isoprene, styrene-butadiene rubber (SBR), acrylonitrile-butadiene rubber, acrylonitrile-butadiene-styrene rubber, crude rubber, acrylates, plasticized elastomers, or combinations of elastomers which provide suitable fiber slippage. In one embodiment, the saturant may provide the paper backing with increased bonding to the primer layer 13. In one embodiment, a SBR saturant on the paper backing improves the bonding of a silicone pressure-sensitive adhesive and silicone primer to the backing and results in a tape with superior cornering capability.

Another layer of the tape's construction is the primer layer 13. The primer layer 13 promotes adhesion between the backing 12 and the silicone pressure-sensitive adhesive (layer 14) such that the tape construction is capable of clean removal from an adherend. The primer may be any substance or composition that is compatible with the silicone pressure-sensitive adhesive that will enhance its adhesion to the backing In one embodiment, the primer includes one or more reactive silane, a condensation catalyst and some type of solvent carrier. The reactive silane typically has two different reactive groups; one that is compatible with the substrate and the other with the adhesive. Some types of groups may be hydrophilic like a silanol group or hydrophobic like a 1-octenyl group. These different groups form a compatible interface between the incompatible substrates and promote adhesion. The reactive silanes may be added as moisture sensitive alkoxy silanes and, in the presence of water and a condensation catalyst, form the priming surface. The reactive species are typically in concentrations of 5% to 20% in solvent. The main job of the solvent is to dilute the reactive species, the silanes and the condensation catalysts, on the surface of the substrate and promote a thin film of these reactive species.

Application methods range from just wiping the primer on a surface to spraying the primer through a paint type sprayer. The primer is applied in a thin, uniform film, allowing the solvent to evaporate and the reactive groups to hydrolyze and condense into a film. The primer may take 30 minutes or more to cure, but curing may be accelerated with the application of heat from about 35° C. to about 80° C.

In one embodiment, the primer layer 13 comprises a silane primer or other silicone containing primer. The primer layer 13 may include a silane primer such as those available from NuSil Silicone Technology, a silicone gum primer such as those available from Momentive Performance Materials, a solution of various reactive siloxanes and silicone resins in a mixture of isoalkanes such as those available from Wacker Chemie AG, and/or other silicone containing primer available from DuPont, or Dow Chemical.

The primer layer 13 may be applied to the first major surface 22 of the foil backing 12 as 100% solids or as part of an aqueous or non-aqueous solution or dispersion. In one embodiment, the primer layer is applied as about 5% to about 15% solids. In one embodiment, the primer layer is applied as about 8% to about 10% solids. The primer layer 13 may be coated onto the foil backing 12 at a coat weight of about 0.1 gsm to about 40 gsm. In another embodiment, the primer layer 13 may have a coat weight of about 10 gsm to about 30 gsm. In another embodiment, the primer layer 13 may have a coat weight of about 20 gsm to about 22 gsm.

In one embodiment, the silicone primer may be a Momentive Performance Materials, Inc. brand silicone such as SS4191A (gum solution), SS4191B (methyl hydrogen crosslinker), SS4192C (a catalyst of 50% solution of dibutyl tin diacetate in toluene), SS4259C (cure accelerator toluene solution of poly(methyl-aminoalkoxy)siloxane polymer) and various combinations thereof.

Another layer of the tape's construction is the pressure-sensitive adhesive layer 14. Pressure-sensitive adhesives useful in the invention include normally tacky, silicone pressure-sensitive adhesives. The silicone pressure sensitive adhesive may be extrudable and typically, though not necessarily, amorphous. In one embodiment, the silicone adhesive compositions are fluid or pumpable at the temperatures used to melt process the tape (e.g., typically 90° C. to 300° C.). Furthermore, these adhesive compositions preferably do not significantly degrade or gel at the temperatures employed during melt processing. Useful adhesive compositions also typically have a melt viscosity of from 1 poise to 100,000 poise. As used herein, the term “melt viscosity” means the viscosity of the molten material at the processing temperature employed.

The silicone pressure-sensitive adhesive layer 14 may be applied to primer layer 13 opposite the first major surface 22 of the backing 12 as 100% solids or as part of an aqueous or non-aqueous solution or dispersion. In another embodiment, the silicone pressure-sensitive adhesive layer 14 may be applied as about 40% solids to about 60% solids. In one embodiment, the silicone pressure-sensitive adhesive may be applied as about 50 to about 55% solids. In one embodiment, the adhesive layer 14 is coated on the backing 12 at a coat weight appropriate for adhesion to a desired surface. The coating weight may be about 8 gsm to about 60 gsm. In another embodiment, the coating weight may be about 20 gsm to about 50 gsm. In another embodiment, the coating weight may be about 40 gsm to about 50 gsm.

A description of useful silicone pressure-sensitive adhesives may be found in Chapter 15 of the Handbook of Pressure-Sensitive Adhesive Technology by Danatas Satas, published by Van Nostrand Reinhold, 1982. Some silicone pressure-sensitive adhesives are dispersion (in organic solvent) of polydimethylsiloxane gum and resin, diluted with xylene.

The following adhesive compounds, solutions, or emulsions may be used, either alone or in combination, without departing from the scope of this invention. In one embodiment, the silicone pressure-sensitive adhesive may be a Dow Corning® brand silicone pressure sensitive adhesive such as Dow Corning® 2013 Solventless PSA (a solvent-free silicone PSA), Dow Corning® 7657 Adhesive/Syl-Off® 4000 catalyst (a polydimethyl siloxane gum and resin dispersed in xylene), Dow Corning®280A adhesive (a dispersion of polydimethylsiloxane gum and resin; high viscosity liquid), Dow Corning® 282 adhesive (a dispersion of polydimethyl disiloxane gum and resin; high viscosity liquid), Dow Corning® 7355 Adhesive (a dispersion of polydimethylsiloxane gum and resin; blendable with a variety of other dimethyl type silicone PSAs), Dow Corning® 7358 adhesive (a dispersion of polydimethylsiloxane gum and resin), and Dow Corning® Q2-7406, Q2-7566, or Q2-7735 (polydimethylsiloxane gum and resin dispersions). These silicone PSAs provide various service temperature ranges, conformability, adhesion to low energy surfaces, and adhesive tack.

In another embodiment, the silicone pressure-sensitive adhesive may be a Momentive Performance Materials, Inc. brand silicone pressure sensitive adhesive such as PSA529 (a toluene solution of polysiloxane gum and resin), PSA590 (a silicone gum and resin), PSA595 (a polymethylsiloxane gum and polysiloxane resin), PSA610 (a toluene solution of polysiloxane gum and resin), PSA6573A (a toluene solution of polysiloxane gum and resin), PSA750 (a toluene solution of polysiloxane gum and resin), PSA910 (a toluene solution of polysiloxane gum and resin), and PSA915 (a toluene solution of polysiloxane gum and resin).

To the silicone pressure sensitive adhesives and primers it is possible to add fillers, plasticizers, catalysts, additional resins, solvents, and other additives as recommended by the manufacturer of the silicone pressure sensitive adhesives and primers.

The masking tape, tape 10, for good performance on semi-permanent release compositions applied to molds, such as fiber glass molds, should have a crosslink density of the silicone pressure-sensitive adhesive layer 14 of about 4 to about 8, or about 5.5. to about 7.5, or about 7 on a scale of 0-8 using the following test—place a 1″×6″ strip of the masking tape into a toluene bath for three minutes, remove, and visually measure how the adhesive hold together to the backing.

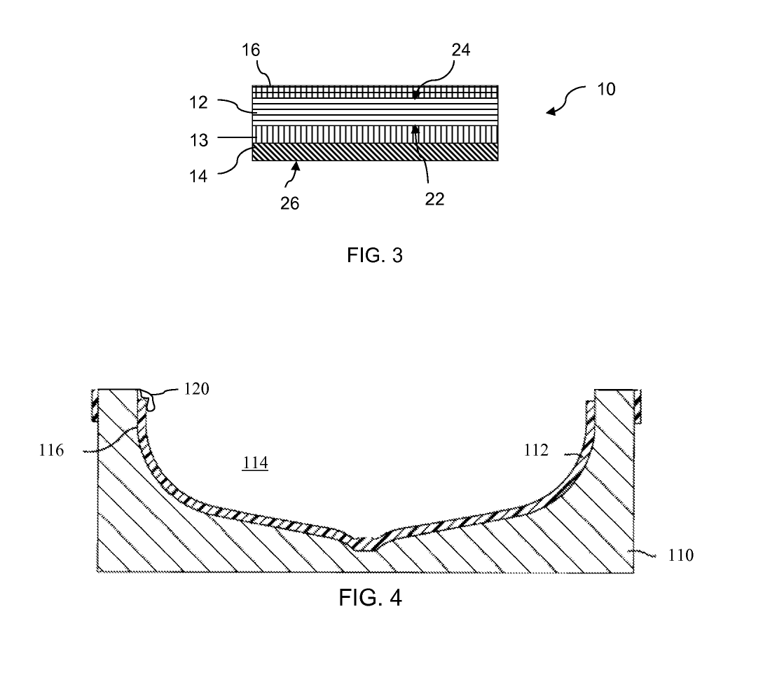

Referring now to FIG. 3, the tape 10 of FIG. 2 may further include top layer 16 disposed on its second major surface 24. The top layer 16 includes a wash coat having a coat weight of about 0.1 gsm to about 0.5 gsm. In one embodiment, the wash coat has a coat weight of about 0.2 gsm.

In another embodiment, the top layer 16 includes a release coat that is releasably compatible with the adhesive layer 14. The release coat may have a coat weight of about 0.1 gsm to about 15 gsm. In one embodiment, the release coat may have a coat weight of about 5 gsm to about 10 gsm. The release coating can be formed from any suitable compound or compounds, such as silicone-containing compounds, vinylacetate-containing compounds, acrylic-containing compounds, or any combination thereof, for example. With the release coat present, rolls of the silicone pressure-sensitive adhesive paper masking tape may have a shelf unwind of about 15-25 oz/in and an aged unwinds of about 30-40 oz/in.

The tapes disclosed herein may include a release liner. Examples of release liners include papers, polymeric film, and woven and nonwoven fabric. The release liner can include a release coating composition including, e.g., silicone, fluorocarbons, carbamate and polyolefins including, e.g., polyethylene and polypropylene. Release liners, when present, can also include reinforcing agents including, e.g., fibers, filaments (e.g., glass fiber filaments), and saturants, e.g., synthetic rubber latex saturated paper backings

The tapes 10 may include other layers and elements found in conventional adhesive tapes, such as reinforcements for adding strength to the tape, release agents, etc.

The tapes 10 disclosed herein may be made using standard tape manufacturing techniques such as slot die coating, reverse roll coating, notch bar coating, curtain coating, knife-over-roll, Mayer rod, air knife and/or gravure.

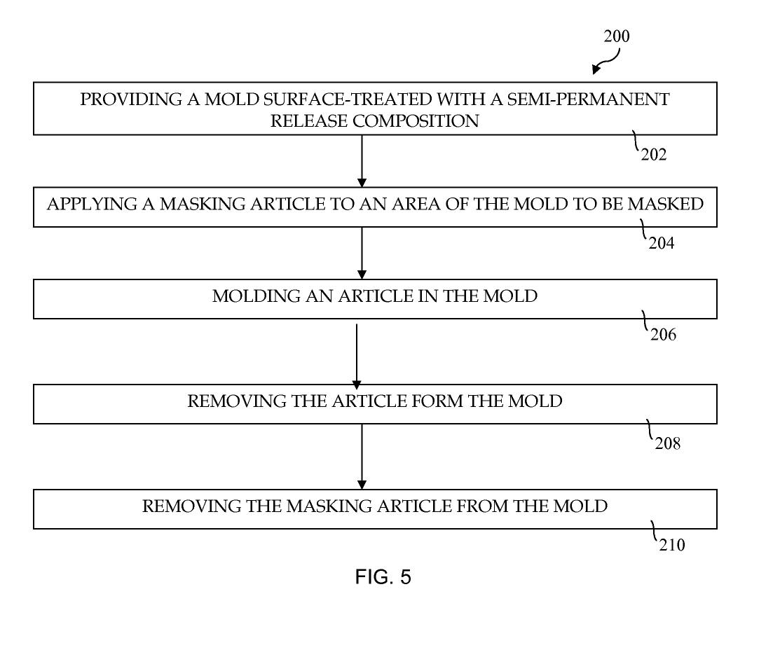

FIG. 5 illustrates a cross-section of a boat hull mold 110 with a semi-permanent release applied thereto as layer 112 inside the mold cavity 114 against the inner surface 116 thereof. The mold cavity inner surface 116 has the desired shape of a boat hull. The semi-permanent releases may be a reactive resin solution designed to crosslink and cure on the mold surface to form a film that, when cured, is highly chemical resistant.

The semi-permanent release layer 112 may be any suitable formulation identified by its manufacturer as “semi-permanent.” In one embodiment, the semi-permanent release agent may be Frekote® semi-permanent release agents (non-silicone materials which bond to tooling surfaces that do not migrate or contaminate parts, machines or the work environment); FORMULA FIVE® semi-permanent mold release system (a proprietary blend of cross-linking polymers in a solvent carrier that bond to a mold surface protecting the mold, preserving fine detail and allowing easy release of parts without transfer) by Rexco, Conyers, Ga.; Chemlease 70-90 semi-permanent mold release agent available from Chem Trend GmbH; or other commercially available or later developed semi-permanent release agents.

Also applied to the mold 110, at least partially in contact with the semi-permanent release layer 112, is a silicone masking article 120 such as one of the silicone masking tapes described above. The silicone masking article 120 is applied thereto to mask the mold or a part to be molded. After the mold is masked, an article may be molded therein, cured or set and then removed from the mold.

Accordingly, a method 200 is disclosed herein that includes the step 202 of providing a mold that is surface-treated with a semi-permanent release composition and the step 204 of applying a masking article to an area of the mold having the semi-permanent release composition. The masking article has a paper backing having opposite first and second major surfaces, the first major surface having a silicone primer layer thereon and a pressure-sensitive silicone adhesive layer on the primer layer with the primer layer positioned between the backing and the adhesive layer. The masking article adheres to the semi-permanent release composition at greater than about 10 oz/in as measured at a 90° angle the surface treated with the release composition and can be cleanly removed therefrom.

The method may also include the step 206 of molding an article in the mold, the step 208 of removing the article form the mold, and the step 210 of removing the masking article from the mold. The masking article 120 as a result of its construction provides clean removal from the surface of the mold 110 and the semi-permanent release layer 112.

### EXAMPLE 1

A silicone masking tape (referred to as Tape 1 in Table 1 below), having a general construction similar to that illustrated in FIG. 3, was made using a reverse roll coat. The masking tape included a SBR saturated paper baking The masking tape included a 8.2 gsm release coat on one side thereof and a 21.2 gsm primer layer, containing 8% solids, on the other side and a 46.9 gsm silicone adhesive layer, containing 54% solids of the silicone adhesive, on the primer layer.

To test Tape 1, mold samples were treated with Axel Mold Releases & Internal Lubricant's XTEND® 818 semi-permanent mold release per the manufacturer's directions. A strip of Tape 1, 1″×6″, was applied to the mold and was tested. In addition, various other standard tests were conducted as listed in Table 1. The same tests were performed on Scapa 2595 silicone masking tape manufactured by Scapa Group plc, United Kingdom.

TABLE 1

| | | | | | Scapa |
|---|---|---|---|---|---|
| | | TAPE 1 | | | 2595 |
| | | Shelf | Wet | Dry | n/a |
| TEST | | | | | |
| Quick stick to Kraft paper | oz/in | 2.4 (0.7) | 1.5 (0.2) | 2.0 (0.1) | 0.4 |
| Quick stick to SS | oz/in | 13.7 (1.2) | 12.2 (1.8) | 14.5 (0.0) | 7.4 |
| 180° Adhesion to SS | oz/in | 28.8 (2.0) | 28.5 (0.8) | 29.2 (0.6) | 20.7 |
| 90° Adhesion to mold with | oz/in | 16.1 (0.4) | 15.2 (1.8) | 15.4 (1.2) | 8.0 (0.8) |
| release composition with 4.5 lb | | | | | |
| roll down. | | | | | |
| 180° Adhesion to Backing | oz/in | 19.4 (1.2) | 18.4 (1.9) | 16.0 (2.8) | 14.8 |
| High Speed Unwind | oz/in | 21 (1) | 25 (3) | 26 | 15 |
| 175° F. | | | | | |
| 180° Adhesion to SS | oz/in | 12.9 (1.0) | 17.1 (1.9) | 16.8 (0.4) | 7.4 |
| Hot peel to Kraft paper | oz/in | 4.5 (0.5) | 3.2 (0.6) | 3.6 (0.4) | 1.1 |
| 180° Adhesion to Backing | oz/in | 9.8 (1.0) | 9.2 (0.1) | 7.2 (0.1) | 2.7 |
| 180° Cool down adhesion to SS | oz/in | 34.7 (1.2) | 33.3 (1.2) | 33.5 (0.7) | 24.9 |
| OTHER TESTS | | | | | |
| Solvent Cure | n/a | 5.5 | 6.5 | 6.5 | 8 |
| Total Caliper | Mils | 6.3 (0.1) | 6.2 (0.1) | 6.3 (0.1) | 5.5 |
| Tensile | #/in | 25.6 (1.2) | 29.2 (2.3) | 23.7 (0.6) | 25.4 |
| Elongation | % | 10.7 (0.6) | 10.9 (0.3) | 11.0 (0.4) | 10.8 |
| 365° F. | | | | | |
| 180° Adhesion to SS for 1 hr | oz/in | 14.8 (0.7) | 12.5 (0.5) | — | 3.9 (0.2) |
| 180° Cool down adhesion to SS | oz/in | 44.7 (1.4) | 41.7 (0.8) | — | 15.7 (0.8) |

As shown by the results in Table 1, Tape 1 had increased adhesion, almost double the adhesion, to the mold coated with the release composition compared to the Scapa 2595 silicone masking tape. Tape 1's adhesion to the semi-permanent release was greater than about 10 oz/in as determined by a 90° adhesion test having a 4.5 lb roll down of the tape or greater than about 14 oz/in.

Tape 1 had increased adhesion to Kraft paper and stainless steel, compared to the Scapa 2595 silicone masking tape, as determined by the quick stick tests and increased adhesion for the 175° F., 180 degree adhesion to stainless steel, the hot peel to Kraft paper, and the 180° adhesion to backing tests.

One area where Tape 1 performs superior is at the 365° F. Tests. Tape 1 did not tear during the cool down 180 degree adhesion test. Instead, it had an adhesion of about 41 oz/in or greater.

One of the key benefits, which is not able to be measured by looking at the raw data is the fact that the Tape 1 corners better as measured by better tear resistance during said cornering. Employing a film tape typically will not allow this. Also, many paper masking tapes exhibit poor cornering, including Scapa 2595.

What is claimed is:

1. A method for masking a mold, the method comprising:
providing a mold comprising a semi-permanent release agent applied thereto;
applying a masking article to an area of the mold to be masked, wherein the masking article is at least partially adhered to the semi-permanent release agent, the masking article comprising:
a backing comprising a paper backing material including a saturant and having opposite first and second major surfaces, the first major surface having a silicone primer layer thereon and a pressure-sensitive silicone adhesive layer on the primer layer with the primer layer positioned between the backing and the adhesive layer;
wherein the masking article adheres to the semi-permanent release composition at greater than about 10 oz/in as measured with a 90° peel test to stainless steel with a 4.5 lb roll down to the surface treated with the release composition.

2. The method of claim 1 wherein the mold includes a mold cavity having an inner surface having a shape of a boat hull, wherein the inner surface has the semi-permanent release agent applied thereto.

3. The method of claim 1 further comprising:
molding an article in the mold;
removing the article from the mold; and
removing the masking article from the mold;
wherein the masking article provides clean removal from the semi-permanent release agent.

4. The method of claim 1 wherein the paper backing material comprises a crepe paper.

5. The method of claim 4 wherein the saturant includes styrene-butadiene rubber.

6. The method of claim 1 wherein the primer layer comprises silicone as about 5% to about 15% weight solids.

7. The method of claims 1 wherein the primer layer comprises silicone as about 8% to about 10% weight solids.

8. The method of claim 1 wherein the primer layer has a coat weight of about 10 gsm to about 30 gsm.

9. The method of claim 1 wherein the second major surface of the backing includes a release coat thereon.

10. The method of claim 1 wherein the masking article comprises a tape, a roll of tape, or a masking sheet.

11. A silicone masking adhesive tape comprising:
a backing comprising a paper backing including a saturant and having opposite first and second major surfaces, the first major surface having a primer layer comprising silicone or silane moieties thereon and a silicone pressure-sensitive adhesive layer on the primer layer with the primer layer positioned between the backing and the adhesive layer;
wherein the masking article adheres to a semi-permanent release composition at greater than about 10 oz/in as measured with a 90° peel test to stainless steel with a 4.5 lb roll down.

12. The silicone masking adhesive tape of claim 11 wherein the masking article adheres to a semi-permanent release composition at greater than about 14 oz/in as with a 90° peal test to stainless steel with a 4.5 lb roll down.

13. The silicone masking adhesive tape of claim 11 wherein the paper backing material comprises a crepe paper.

14. The silicone masking adhesive tape of claim 11 wherein the saturant includes styrene-butadiene rubber.

15. The silicone masking adhesive tape of claim 11 wherein the primer layer comprises silicone as about 5% to about 15% weight solids and has a coat weight of about 10 gsm to about 30 gsm.

16. The silicone masking adhesive tape of claim 11 wherein the primer layer comprises silicone as about 8% to about 10% weight solids and has a coat weight of about 10 gsm to about 30 gsm.

17. The silicone masking adhesive tape of claim 11 wherein the second major surface of the backing includes a release coat thereon and the masking tape comprises a roll of tape.
